(19) United States
(12) Patent Application Publication
(10) Pub. No.: US 2014/0216401 A1
(43) Pub. Date: Aug. 7, 2014

(54) COMBUSTION SYSTEM CONFIGURED TO GENERATE AND CHARGE AT LEAST ONE SERIES OF FUEL PULSES, AND RELATED METHODS

(71) Applicant: ClearSign Combustion Corporation, Seattle, WA (US)

(72) Inventors: JOSEPH COLANNINO, MERCER ISLAND, WA (US); ROBERT E. BREIDENTHAL, SEATTLE, WA (US); IGOR A. KRICHTAFOVITCH, KIRKLAND, WA (US); CHRISTOPHER A. WIKLOF, EVERETT, WA (US)

(73) Assignee: ClearSign Combustion Corporation, Seattle, WA (US)

(21) Appl. No.: 14/172,603

(22) Filed: Feb. 4, 2014

Related U.S. Application Data
(60) Provisional application No. 61/760,631, filed on Feb. 4, 2013.

(51) Int. Cl. F02D 41/30

(52) U.S. Cl. CPC F02D 41/30
USPC 123/406.12

(57) ABSTRACT

A pulsed electrical charge or voltage may be applied to a pulsed fuel stream or combustion reaction supported by the fuel stream. The pulsed charge or voltage may be used to affect fuel mixing, flame trajectory, heat transfer, emissivity, reaction product mix, or other physical property of the combustion reaction.

### CROSS-REFERENCE TO RELATED APPLICATIONS

This application claims priority benefit from U.S. Provisional Patent Application No. 61/760,631 filed 4 Feb. 2013 that, to the extent not inconsistent with the disclosure herein, is incorporated by reference.

### BACKGROUND

Thermally produced NOₓ (e.g., NO and NO₂) is one of the largest contributors to air pollution. Thus, NOₓ reduction is an area of significant concern. Thermal NOₓ is produced during combustion processes and does not form in significant concentrations until flame temperatures reach approximately 2700° F.

Increased levels of NO in the atmosphere may cause various harmful environmental and health effects. In the atmosphere, NO is rapidly oxidized to NO₂, which is an essential constituent in the formation of tropospheric ozone and photochemical smog. Additionally, NO₂ may be oxidized to form nitric acid, which may be deposited as acid rain. Moreover, NOₓ may combine with other pollutants in the atmosphere to create ozone (O₃).

New legislation on NOₓ emissions has limited combustion system design. Many technologies have been designed in order to reduce NOₓ emissions. For example, technologies that reduce flame temperature may also reduce flame stability or increase CO emissions. Thus, combustion system design has become an important field of study.

NOₓ generated in combustion processes may be reduced with either pre-combustion or post-combustion technologies. Post-combustion technologies break down NOₓ emissions in the exhaust gases, while pre-combustion methods prevent the formation of NOₓ. Pre-combustion methods may include staging the combustion process and recirculating flue gases into the combustion process.

### SUMMARY

Embodiments disclosed herein are directed to a combustion system configured to generate and charge at least one series of fuel pulses, and related methods. In an embodiment, a combustion system includes a controller, a fuel control apparatus operatively coupled to the controller, at least one voltage source operatively coupled to the controller, and at least one fuel ionizer. The fuel control apparatus is configured to output a series of fuel pulses into a combustion volume responsive to control by the controller. The at least one voltage source is configured to output at least one series of high voltage pulses responsive to control by the controller. The at least one ionizer is configured to receive the at least one series of high voltage pulses and eject charges onto one or more of the at least one series of fuel pulses to charge the at least one series of fuel pulses.

In an embodiment, a method for controlling a combustion reaction includes modulating a fuel control apparatus to output a series of fuel pulses, modulating an ionizer to apply charges to the series of fuel pulses, and supporting a combustion reaction with the series of charged fuel pulses.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

FIG. 1 is a diagram of a combustion system according to an embodiment.

FIG. 2 is a flow chart of a method for operating a combustion system according to an embodiment.

FIG. 3 is a diagram of a combustion system that may employ a pulsing mechanism and feedback control system for the generation of a flame according to an embodiment.

FIG. 4 illustrates fuel staging process in which fuel packets may be injected into combustion chamber through a pulsing mechanism according to an embodiment.

FIGS. 5A and 5B illustrate waveforms according to different embodiments.

FIG. 6 is an isometric cutaway view of an embodiment of a pulsing mechanism, which may include a rotative gate system to pulse fuel into combustion chamber.

FIG. 7 is an isometric cutaway view of an embodiment of a pulsing mechanism, which may include a cylindrical gate system to pulse fuel into combustion chamber.

FIG. 8 a diagram of an embodiment of a pulsing system including an arrangement of one or more Helmholtz resonators.

FIG. 9 illustrates an embodiment of a pulsing system in which an insulator injector may be used for pulsing air and/or fuel.

### DETAILED DESCRIPTION

Embodiments disclosed herein are directed to a combustion system configured to generate and charge at least one series of fuel pulses, and related methods. In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

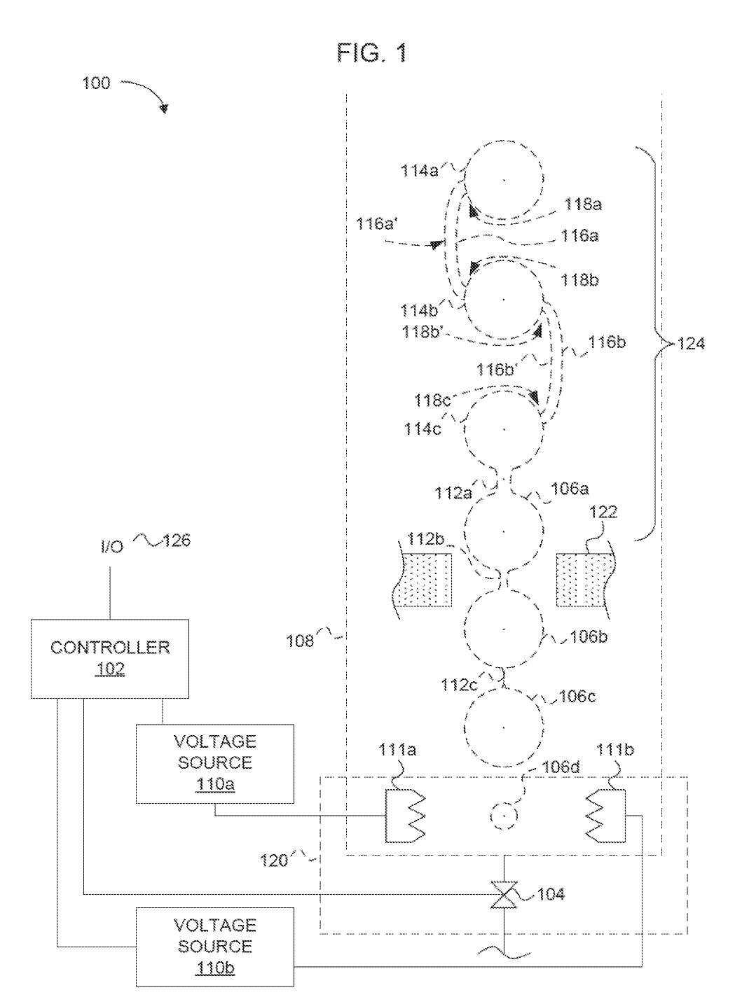

FIG. 1 is a diagram of a combustion system 100 according to an embodiment. The combustion system 100 includes a controller 102 and a fuel control apparatus 104. The fuel control apparatus 104 is operatively coupled to the controller 102. The fuel control apparatus 104 may be responsive to control by the controller 102 and output a series of fuel pulses 106a, 106b, 106c, 106d into a combustion volume 108.

The combustion system 100 further includes a first voltage source 110a and a first ionizer 111a. The first voltage source 110a is operatively coupled to the controller 102. The first voltage source 110a is responsive to control by the controller 102 and outputs a first series of high voltage pulses. The first ionizer 111a is configured to receive the first series of high voltage pulses and eject first charges onto one or more of the series of fuel pulses 106b, 106d to charge the series of fuel pulses 106a, 106b, 106c, 106d.

The controller 102 may be configured to cause the fuel control apparatus 104 and the first ionizer 111a to cooperate to output a series of fuel pulses 106a, 106b, 106c, 106d. The series of fuel pulses 106a, 106b, 106c, 106d may carry sequentially opposite polarity charges. For example, the first ionizer 111a may eject positive charges when a fuel pulse 106a is proximate and eject negative charges when a fuel pulse 106b is proximate. This pattern may continue such that fuel pulse 106c is charged positively and fuel pulse 106d is charged negatively.

The series of fuel pulses 106a, 106b, 106c carrying sequentially opposite polarity charges may be electrostatically attracted to one another and form a series of fuel streams 112a, 112b, 112c that flow together to form respective vortices 114a, 114b, 114c. Additionally and/or alternatively, the series of fuel pulses 106a, 106b, 106c carrying sequentially opposite polarity charges may be electrostatically attracted to one another and may be selected to form a series of vortices 114a, 114b, 114c separated in space from one another. The series of fuel pulses 106a, 106b, 106c carrying sequentially opposite polarity charges may be selected to form Taylor layers 116a, 116a′, 116b, 116b′ between the series of vortices 114a, 114b, 114c.

The electrostatically-driven flow of the Taylor layers 116a, 116a′, 116b, 116b′ into the series of vortices 114a, 114b, 114c may be selected to cause air or flue gas engulfment 118a, 118b, 118b′, 118c into the respective vortices 114a, 114b, 114c. Additionally and/or alternatively, the electrostatically-driven flow of the Taylor layers 116a, 116a′, 116b, 116b′ into the series of vortices 114a, 114b, 114c may be selected to cause air and/or flue gas engulfment 118a, 118b, 118b′, 118c into the respective vortices 114a, 114b, 114c at a selected mixing rate in the vortices 114a, 114b, 114c corresponding to a Damkohler Number equal to or greater than 1.

In the illustrated embodiment, the combustion system 100 further includes a second voltage source 110b and a second ionizer 111b. However, in other embodiments, the second voltage source 110b may be omitted. The second voltage source 110b may be operatively coupled to the controller 102. The second ionizer 111b may be operatively coupled to the second voltage source 110b. The first voltage source 110a may be configured to output a first unipolar voltage. The second voltage source 110b may be configured to output a second unipolar voltage opposite in sign from the first unipolar voltage.

The controller 102 may be configured to cause the fuel control apparatus 104 and the first ionizer 111a to cooperate to output a series of fuel pulses 106a, 106c carrying first polarity charges. Additionally and/or alternatively, the controller 102 may be configured to cause the fuel control apparatus 104 and the second ionizer 111b to cooperate to output a series of fuel pulses 106b, 106d. The series of fuel pulses 106b, 106d may carry second polarity charges opposite in polarity from the first polarity charges.

The series of fuel pulses 106a, 106b, 106c carrying sequentially opposite polarity charges may be electrostatically attracted to one another and may form a series of fuel streams 112a, 112b, 112c. The series of fuel streams 112a, 112b, 112c may flow together to form respective vortices 114a, 114b, 114c. Additionally and/or alternatively, the series of vortices 114a, 114b, 114c may be separated in space from one another.

According to an embodiment, the series of fuel pulses 106a, 106b, 106c carrying sequentially opposite polarity charges may be selected to form Taylor layers 116a, 116a′, 116b, 116b′ between the series of vortices 114a, 114b, 114c. Additionally and/or alternatively, the electrostatically-driven flow of the Taylor layers 116a, 116a′, 116b, 116b′ into the series of vortices 114a, 114b, 114c may be selected to cause air or flue gas engulfment 118a, 118b, 118b′, 118c into the respective vortices 114a, 114b, 114c. A mixing rate in the vortices 114a, 114b, 114c may be selected. The selected mixing rate may correspond to a Damkohler Number equal to or greater than 1.

In an embodiment, the fuel control apparatus 104 and the first ionizer 111a may be configured as an electrostatic ionizing fuel injector 120. For example, U.S. Pat. No. 8,245,951; which, to the extent not inconsistent with the disclosure herein, is incorporated by reference, and discloses suitable charge injectors that may be used with the combustion systems disclosed herein.

In an embodiment, the fuel control apparatus 104, the first ionizer 111a, and the second ionizer 111b may be configured as a bipolar electrostatic ionizing fuel injector 120. The first ionizer 111a may be configured as a first ion-ejecting mesh. The second ionizer 111b may be configured as a second ion-ejecting mesh electrically insulated or isolated from the first ion-ejecting mesh.

In an embodiment, the first ionizer 111a may include and/or be configured as a first carbon nanotube (CNT) coating, and the second ionizer 111b may include and/or be configured as a second CNT coating electrically insulated and/or isolated from the first CNT coating.

In the illustrated embodiment, the combustion system 100 further includes a flame holder 122. However, in other embodiments, the flame holder 122 may be omitted. The flame holder 122 may be configured to anchor a flame 124 formed as a series of vortices 114a, 114b, 114c. The series of vortices 114a, 114b, 114c may be formed from the series of charged fuel pulses 106a, 106b, 106c, 106d. The flame holder 122 may include a grounded conductor and may include a bluff body. The flame 124 may include charged Taylor layers 116a, 116a′, 116b, 116b′ between the vortices 114a, 114b, 114c.

In some embodiment, the combustion system 100 may include a data communication interface 126 included and/or operatively coupled to the controller 102. The controller 102 may be configured to receive data through the data communication interface 126 and may select the fuel control apparatus 104 and ionizer pulse frequency responsive to the received data. Additionally and/or alternatively, the controller 102 may be configured to receive data through the data communication interface 126 and may select a voltage source 110a output voltage responsive to the received data.

In an embodiment, the fuel control apparatus 104 may include a fuel flow modulator. For example, the fuel flow modulator may include one or more of a piezoelectric valve, an electro-magnetic valve, a rotary valve, a slide valve, an actuated ball valve, or a micro-electro-mechanical system (MEMS) valve configured to modulate fuel flow from the fuel control apparatus 104.

In operation, the controller 102 may to receive data through the data communication interface 126 and may select a maximum modulated fuel flow rate of the fuel flow modulator responsive to the received data. The controller 102 may be configured to cause the fuel control apparatus 104 and the first ionizer 111a to output charged fuel pulses 106a, 106b, 106c, 106d at one or more frequencies. For example, the one or more frequencies may be selected to avoid resonance in the combustion volume 108. Additionally and/or alternatively, the one or more frequencies may be sub-harmonics of a resonance frequency of the combustion volume 108.

In other embodiments, the controller 102 may be configured to cause the fuel control apparatus 104 and the first ionizer 111a to output charged fuel pulses 106a, 106b, 106c, 106d at a spread spectrum of frequencies. The spread spectrum of frequencies may be selected to avoid resonance in the combustion volume 108.

In other embodiments, the controller 102 may be configured to cause the fuel control apparatus 104 and the ionizer 111a to output charged fuel pulses 106a, 106b, 106c, 106d at a range of frequencies. For example, the range of frequencies may include a low frequency corresponding to a low heat output rate from a flame 124. As another example, the range of frequencies may include a high frequency corresponding to a high heat output rate from a flame 124. The flame 124 may be supported by the charged fuel pulses 106a, 106b, 106c, 106d.

As yet another example, the controller 102 may be configured to cause the fuel control apparatus 104 and the ionizer 111a to output charged fuel pulses 106a, 106b, 106c, 106d at a low fuel volume per pulse. The low fuel volume per pulse may correspond to a low heat output rate from a flame 124 supported by the charged fuel pulses 106a, 106b, 106c, 106d. The ionizer 111a may be configured to apply a low total charge to the low fuel volume pulses 106a, 106b, 106c, 106d

Additionally and/or alternatively, the controller 102 may be configured to cause the fuel control apparatus 104 and the first ionizer 111a to output charged fuel pulses 106a, 106b, 106c, 106d at a high fuel volume per pulse. The high fuel volume per pulse may correspond to a high heat output rate from a flame 124 supported by the charged fuel pulses 106a, 106b, 106c, 106d. The ionizer 111a may be configured to apply a high total charge to the high fuel volume pulses 106a, 106b, 106c, 106d. The controller 102 may be configured to drive the first voltage source 110a to output a voltage proportional to a fuel flow rate of the fuel flow apparatus 104. Additionally and/or alternatively, the controller 102 may be configured to drive the fuel control apparatus 104 to output a fuel flow rate proportional to the first voltage source 110a output voltage.

In certain embodiments, the fuel pulses 106a, 106b, 106c, 106d may be formed as a fuel aerosol.

In some embodiments, the combustion system 100 may include one or more field electrodes. The one or more field electrodes may be configured to apply one or more electric fields to drive movement of the charged fuel pulses 106a, 106b, 106c, 106d and/or charged vortices produced by the charged fuel pulses.

The first voltage source 110a and/or the first and second voltage sources 110a, 110b may be configured to cause the first ionizer 111a and/or first and second ionizers 111a, 111b to output unequal amounts of positive and/or negative ions onto the series of fuel pulses 106a, 106b, 106c, 106d such that combustion vortices 114a, 114b, 114c produced by the fuel pulses carry a bias charge or bias voltage.

The formation of the vortices 114a, 114b, 114c may generally cause recombination of opposite charges carried by donor fuel pulses. When the number of positive charges carried by one fuel pulse is substantially equal to the number of negative charges carried by a sequentially neighboring fuel pulse, the net charge carried by the combustion reaction 124 may be neutral. In some embodiments, the combustion reaction 124 to carry a net charge. For example, one or more field electrodes may apply one or more electric fields to cause a selected movement, selected heat transfer, selected radiated blackbody emission, etc. of or from the combustion reaction 124. A residual bias charge or bias voltage may be created in the combustion reaction 124 by applying a biased charge to the fuel pulses 106a, 106b, 106c, 106d. The biased fuel charge may consist essentially of unequal numbers of positive and negative charges applied to successive fuel pulses.

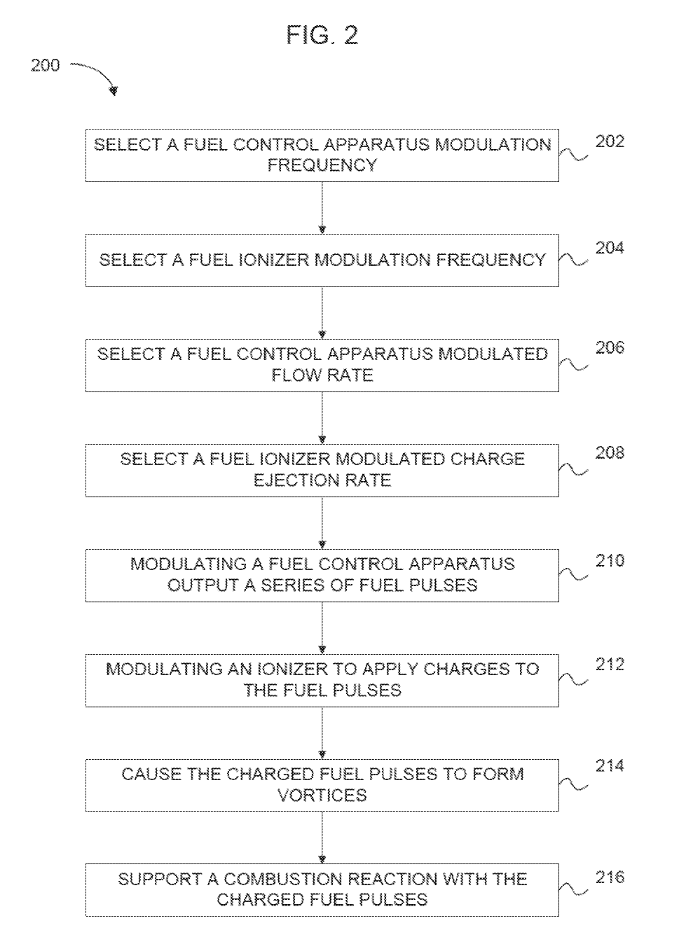

One or more embodiments are directed to a method for controlling a combustion reaction includes modulating a fuel control apparatus to output a series of fuel pulses, modulating an ionizer to apply charges to the series of fuel pulses, and supporting a combustion reaction with the series of charged fuel pulses. FIG. 2 is a flow chart of a method for operating a combustion system according to a more specific embodiment. For example, the method 200 may be implemented by one or more of the embodiments of the combustion system 100 disclosed herein.

According to an embodiment, in act 202, a fuel control apparatus may select a modulation frequency. The modulation frequency may be selected to be proportional to an ionizer modulation frequency. In act 204, an ionizer modulation frequency may be selected. The ionizer modulation frequency may be selected to be proportional to a fuel control apparatus modulation frequency. In act 206, a fuel control apparatus modulated flow rate may be selected. The fuel control apparatus modulated flow rate may be selected to be proportional to an ionizer charge ejection rate. In act 208, an ionizer modulated charge ejection rate may be selected. The ionizer modulated charge ejection rate may be selected to be proportional to a fuel control apparatus modulated flow rate, for example. According to an embodiment, an ionizer modulated charge phase may be included. The ionizer modulated charge phase may be selected relative to a fuel control apparatus modulation phase to synchronize charge output to a presence of a modulated fuel pulse. In act 210, a fuel control apparatus may be modulated to output a series of fuel pulses. In act 212, an ionizer may be modulated to apply charges to the series of fuel pulses. In act 214, the charged fuel pulses may cause vortices to form. In act 216 a combustion reaction may be supported with the series of charged fuel pulses.

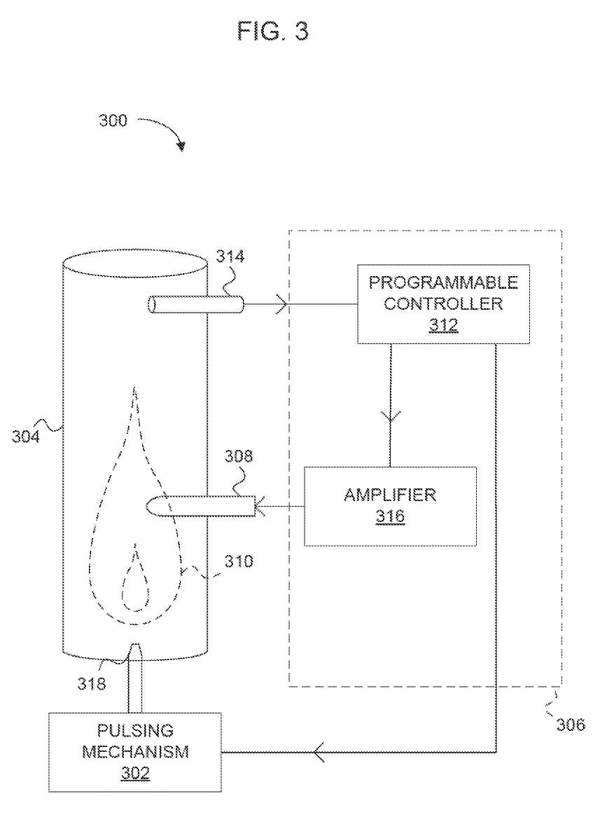

FIG. 3 depicts an embodiment of a combustion system 300 including a pulsing mechanism 302, a combustion chamber 304 and a feedback control system 306. The combustion chamber 304 may include one or more electrodes 308 configured to apply charge, voltage, electric field, or combinations thereof to flame 310. A variety of electrode 308 configurations may be employed depending on the application, and a plurality of waveforms and current intensities may be applied to the flame 310 via the electrodes 308.

The feedback control system 306 may include a programmable controller 312, one or more probes 314, and an amplifier 316. A “probe” may refer to a sensor device, which may detect and measure one or more combustion parameters such as temperature, emissions, luminosity, among others.

The amplifier 316 and the pulsing mechanism 302 may be connected to the programmable controller 312, which manages the application of charge, voltage, electric field, or combinations thereof to the flame 310 through the electrode 308, as well as controlling the pulsing frequency of the fuel supplied by the pulsing mechanism 302.

The pulsing mechanism 302 may be employed for injecting fuel and/or air in pulses into the combustion chamber 304 for producing the flame 310. According to various embodiments, the pulsing mechanism 302 is employed to inject fuel.

The feedback control system 306 may be responsible for analyzing parameters measured by the probes 314 which may be located in different regions of the combustion chamber 304. The probes 314 may detect a variety of combustion and electric parameters in the flame 310, such as NOₓ and CO in exhaust gases. Such parameters may be communicated to the programmable controller 312 to determine behavior and characteristics of the flame 310 during combustion. Suitable probes 314 may include thermal, electric, optical sensors, among others.

The programmable controller 312 may calculate different characteristics of the flame 310, according to the probes 314 input. Subsequently, the programmable controller 312 may send a control signal to the amplifier 316 in order to energize the electrodes 308 for a corresponding application of voltage, charge, and or electric field that may adjust different characteristics of the flame 310 such as flame shape, position, luminosity and the like, according to the application.

The flame 310 may exhibit a positive charge due to a majority amount of positively charged species in the flame 310, generated during combustion. In an embodiment, a nozzle 318 may be charged to function as a charging electrode 308 to induce a majority of charge to the flame 310.

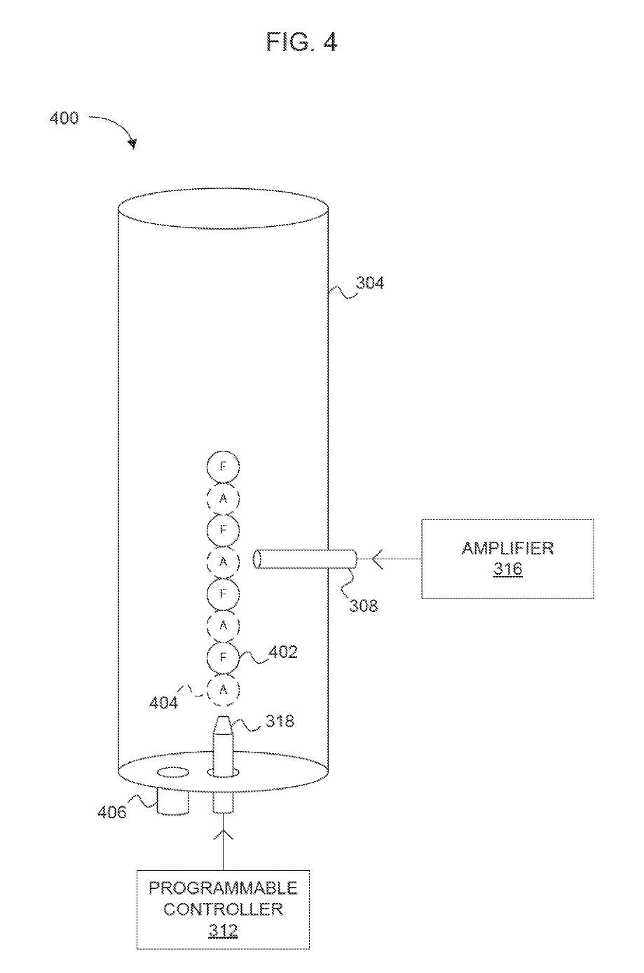

According to various embodiments, using the combustion systems disclosed herein for staging a combustion process and applying charge, voltage, electric field, or combinations thereof to a flame may increase one or more of heat transfer, improve mixing of reactants, lower combustion temperatures, or reduce harmful emissions such as NOₓ and CO. For example, FIG. 4 illustrates a fuel staging process 400 in the combustion system 300 in which fuel packets 402 may be injected into the combustion chamber 304. The pulsing mechanism 302 (as shown in FIG. 3) may include a pulsing frequency described as an ON/OFF sequence of pulses driven by the programmable controller 312. The pulsing mechanism 302 may allow the injection of the fuel packets 402 into the combustion chamber 304, while air packets 404 may enter through an air inlet port 406. For example, the pulsing mechanism 302 or any pulsing mechanism disclosed herein may include rotative devices, Helmholtz resonators, or insulated injectors. When the fuel staging process 400 is ON, the fuel packets 402 may be injected into the combustion chamber 304. On the other hand, during OFF mode, air packets 404 may be formed. The ON/OFF sequence of the pulsing mechanism 302 may be driven by a control waveform generated by the programmable controller 312, which may also synchronize the application of charge, voltage, electric field, or combinations thereof to the flame 310 through the electrode 308. In an embodiment, the programmable controller may generate a single waveform to control pulsing mechanisms and energization of the electrodes. In another embodiment, the programmable controller may generate two different waveforms with a phase relationship to control pulsing mechanism and energization of electrodes.

The fuel staging process 400 may allow a higher accuracy of fuel injection since more precise volumes of fuel may be delivered when needed. Furthermore, combustion with smaller fuel volumes such like fuel packets 402, may allow combustion with lower temperature, which may reduce NOₓ production and improve heat transfer since less heat is wasted by convection.

According to various embodiments, a plurality of pulsing mechanisms may be employed in order to stage combustion by pulsing fuel in liquid, solid, or gaseous state and/or air. For example, the pulsing mechanisms may include rotative devices, Helmholtz resonators, or insulated injectors. The pulsing mechanisms may pulse fuel packets while being synchronized with the application of charge, voltage, electric field, or combinations thereof to a flame through one or more electrodes. The synchronization of pulsed fuel packets and application of a voltage, charge, electric field, or combinations thereof to the flame may be performed by a programmable controller operating within a feedback control system.

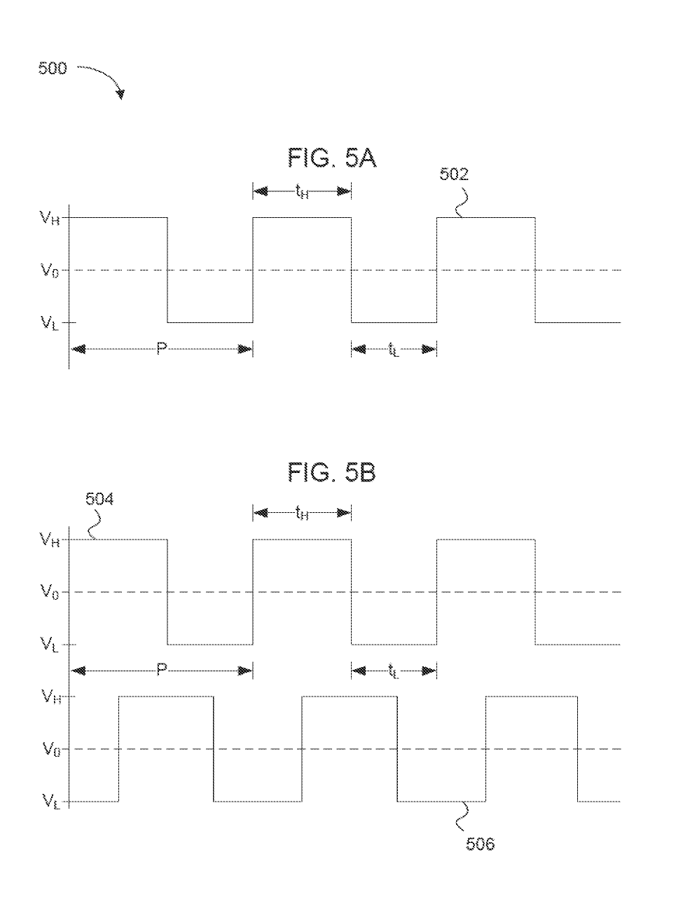

FIG. 5A illustrates an embodiment of a waveform 500 that may be generated by the programmable controller 312 (as shown in FIG. 3) to synchronize the fuel staging process 400 (as shown in FIG. 4) with the application of charge, voltage, electric field, or combinations thereof to the flame 310 through the electrode 308. The waveform 500 may be modulated between high voltage V_{H} and low voltage V_{L} in a pattern characterized by period P. The high voltage V_{H} and low voltage V_{L} may be selected as equal magnitude variations above and below a mean voltage V₀, whereby mean voltage V₀ may be a ground voltage. The period P may include a duration t_{L} corresponding to low voltage V_{L} and another duration t_{H} corresponding high voltage V_{H}, where t_{L} plus t_{H} may equal P.

For example, when the waveform 500 is at V_{H}, the pulsing mechanism 302 may operate at ON mode and feed a fuel packet 402 to the flame 310, where the size of the fuel packet 402 may depend on duration t_{H}, as well as the fuel flow rate. Simultaneously, when the waveform 500 is at V_{H}, the electrode 308 may apply a positive charge to the flame 310. Subsequently, at V_{L}, the pulsing mechanism 302 may switch to OFF mode and stop the supply of the fuel packet 402 to the flame 310 within duration t_{L}. Substantially simultaneously, when the waveform 502 is at V_{L}, the electrode 308 may apply a negative charge to flame 310. The process may continue with the synchronized application of the fuel packets 402 and electric charges to the flame 310.

Referring now to FIG. 5B, two different waveforms 504 and waveform 506 may be generated by the programmable controller 312 to drive the electrode 308 and the pulsing mechanism 302, respectively. The waveform 504 may drive the electrode 308 for the application of positive and negative charges to the flame 310, while the waveform 506 may drive the pulsing mechanism 302 for the injection of the fuel packets 402 to the flame 310. As shown in FIG. 5B, the waveform 504 may exhibit a phase shift or a lag of about 50% with respect to the waveform 506.

Additionally, various effects may be produced over the fuel packets 402 and the air packets 404 according to the disclosed waveforms. Additionally, the disclosed waveforms may present a plurality of shapes, frequencies, periods, amplitudes, and phase shifts according to the application.

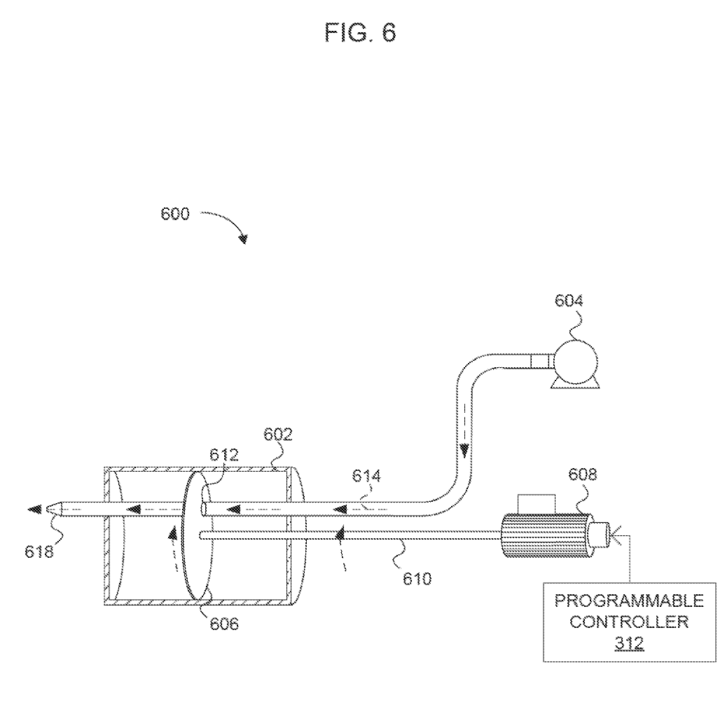

FIG. 6 depicts an embodiment of the pulsing mechanism 302 in which a rotative gate system 600 is employed in order to inject the fuel packets 402 into the flame 310. The rotative gate system 600 may inject the fuel packets 402 in stages of time and space, enabling an improved mixing rate and ignition. The rotative gate system 600 may inject a variety of liquid or gas fuels, depending on the application.

The rotative gate system 600 may include a pressure chamber 602, a pump 604, a rotative gate 606, a mechanical driver 608, and a shaft 610. The rotative gate system 600 may be connected to the programmable controller 312 through the mechanical driver 608.

Fuel 614 may be delivered to the pressure chamber 602 by the pump 604. The pressure chamber 602 may enclose the rotative gate 606, which may have an aperture 612. Moreover, the rotative gate 606 may be connected to the mechanical driver 608 by the shaft 610, whereby the mechanical driver 608 may be driven by the programmable controller 312. Suitable mechanical drivers 608 may include electric engines, internal combustion engines, turbines, and the like.

As the rotative gate 606 swivels, the aperture 612 may be either aligned or unaligned with respect to the nozzle 618, allowing or stopping the supply of the fuel packet 402 to the flame 310. Alignment of the aperture 612 may determine the ON/OFF sequence of the pulsing mechanism 302, whereby alignment of aperture 612 may depend on the angular speed of mechanical driver 608 driven by the programmable controller 312 using the waveforms 502, 506.

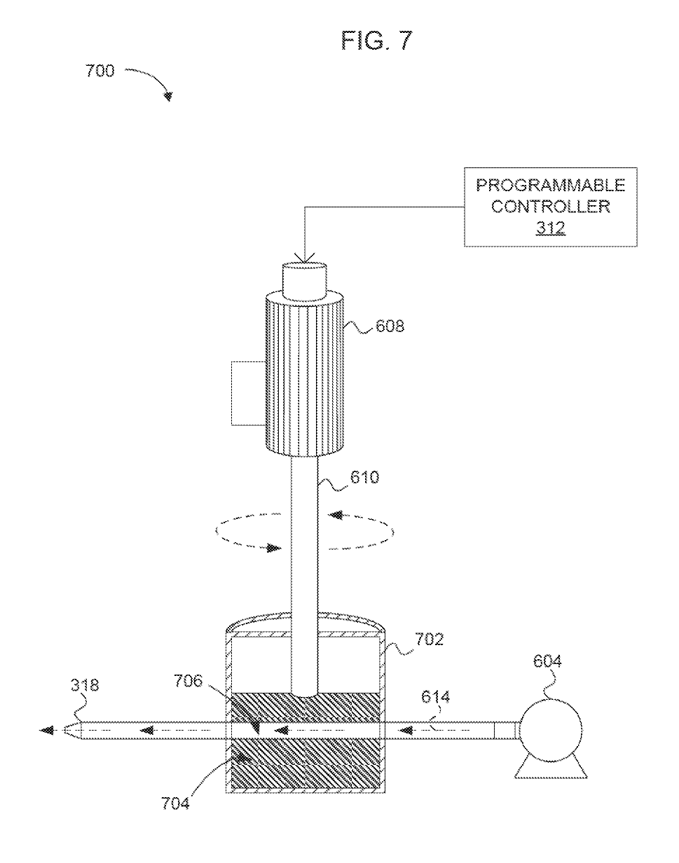

FIG. 7 illustrates an embodiment of the pulsing mechanism 302 in which a generally cylindrical gate system 700 is employed to inject the fuel packets 402 into the flame 310. The cylindrical gate system 700 may inject the fuel packets 402 in stages of time and space, enabling an improved mixing rate and ignition. The cylindrical gate system 700 may inject a variety of liquid or gas fuels, depending on the application.

In an embodiment, the cylindrical gate system 700 may pulse the fuel packets 402 into the flame 310. The cylindrical gate system 700 may include a pressure chamber 702, the pump 604, a cylindrical gate 704, the mechanical driver 608, and the shaft 610. The cylindrical gate system 700 may be connected to the programmable controller 312 through the mechanical driver 608.

Fuel 614 may be delivered to the pressure chamber 702 by the pump 604. The pressure chamber 702 may enclose the cylindrical gate 704, which may have a passage 706. Moreover, the cylindrical gate 704 may be connected to the mechanical driver 608 by the shaft 610, whereby the mechanical driver 608 may be driven by the programmable controller 312. Suitable mechanical drivers 608 may include electric engines, internal combustion engines, turbines, and the like.

As the cylindrical gate 704 swivels, the passage 706 may be either aligned or unaligned with respect to the nozzle 318, allowing or stopping the supply of the fuel packet 402 to the flame 310. Alignment of the passage 706 may determine the ON/OFF sequence of the pulsing mechanism 302, whereby alignment of the passage 706 may depend on the angular speed of the mechanical driver 608 driven by the programmable controller 312 using the waveforms 502, 506.

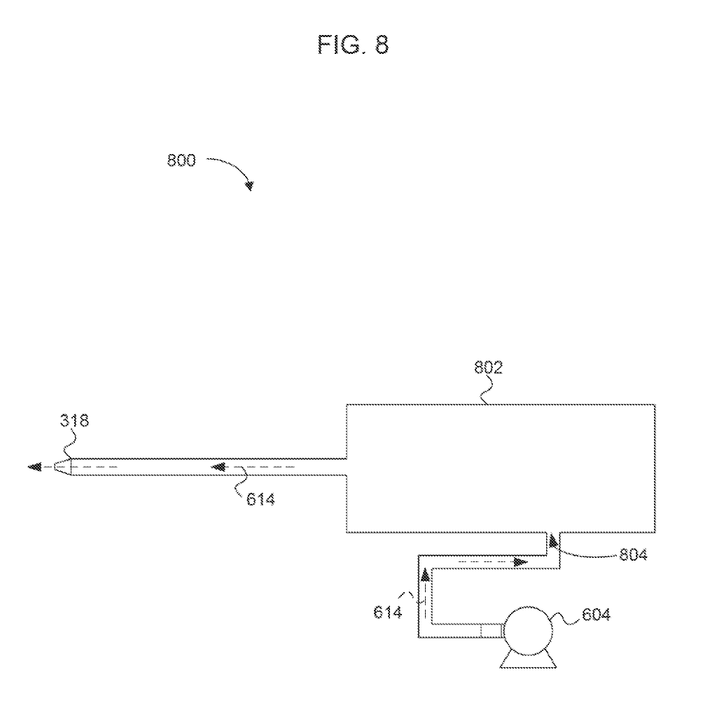

FIG. 8 illustrates an embodiment of the pulsing mechanism 302 in which a Helmholtz resonance system 800 may be used to inject fuel and/or air into the combustion chamber 304. The Helmholtz resonance system 800 may inject a variety of liquid or gas fuels, depending on the application. In an embodiment, the Helmholtz resonance system 800 may inject the fuel packets 402 to the flame 310. The Helmholtz resonance system 800 may include a Helmholtz resonator 802, an inlet port 804, the nozzle 318, and the pump 604. For example, as used herein, a “Helmholtz resonator” may refer to a container, which may induce a natural resonant frequency in fluids. A “natural resonant frequency” may refer to a frequency at which a fluid or a system naturally oscillates when it has been set into motion.

The pump 604 may deliver the fuel 614 to the Helmholtz resonator 802, which may connect the inlet port 804 to the nozzle 318. The Helmholtz resonator 802 may resonate the fuel 614 to induce the formation of the fuel packets 402 at the nozzle 318. The Helmholtz resonator 802 has the ability of increasing or decreasing natural resonant frequencies of incoming fuel 614. Furthermore, frequency of pulsations may be directly related to shape, volume and size of the Helmholtz resonator 802, the inlet port 804 and the nozzle 318, as well as speed of the fuel 614 flowing through the Helmholtz resonator 802 and fuel 614 characteristics, such as viscosity and density.

More than one Helmholtz resonator 802 may be employed in order to achieve different frequency ranges of the fuel packets 402 pulsations. When a plurality of Helmholtz resonators 802 with different or same sizes are employed, a plurality of permutations in frequencies may be achieved. Since Helmholtz resonators 802 do not have moving parts, reliability in the entire pulsed fuel system may be increased, also reducing maintenance costs.

The Helmholtz resonance system 800 may be in synchronization with the application of a charge, voltage, electric field, or combinations thereof to the flame 310. Period P of the waveforms 502, 504 for driving the electrode 308 may be synchronized with a permanent frequency configured in the Helmholtz resonance system 800.

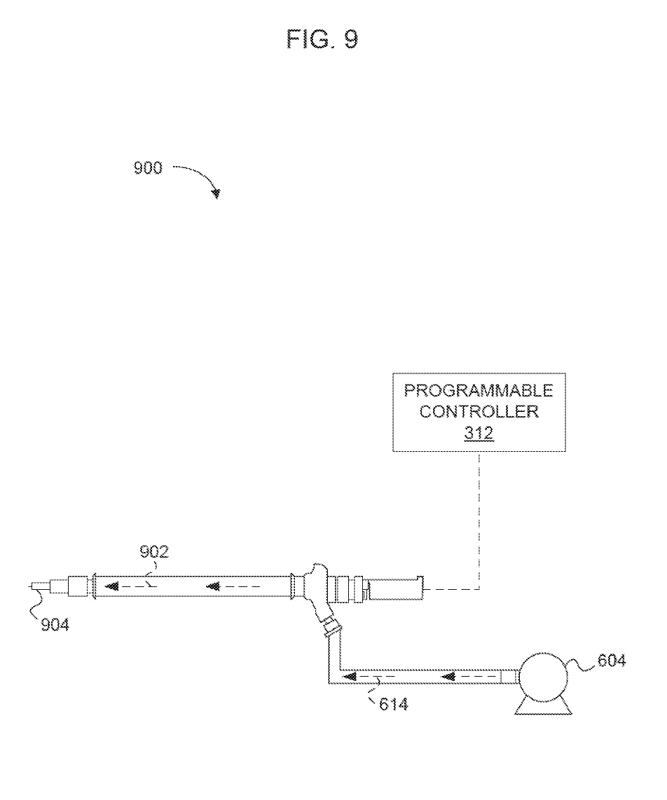

FIG. 9 illustrates an embodiment of the pulsing mechanism 302 in which an insulated injector system 900 may inject the fuel packets 402 to the flame 310. The insulated injector system 900 may inject a variety of liquid or gas fuels, according to the application.

The insulated injector system 900 may include an insulated injector 902, the pump 604, and the nozzle 904. In addition, the insulated injector system 900 may be connected to the programmable controller 312 in the feedback control system 306.

Fuel 614 may be delivered to the insulated injector 902 through the pump 604. The insulated injector 902 may be isolated from electric fields generated by the electrode 308. Electrical insulation may be required for protecting sensitive components of the insulated injector system 900. The insulated injector system 900 may include solenoid injectors, piezoelectric injectors, mechanically driven injectors and the like.

The nozzle 904 in the insulated injector system 900 may be opened or closed according to the ON/OFF sequence required for pulsing the fuel packets 402 into the flame 310. The programmable controller 312 may drive the open/close operation of the nozzle 904 using the waveforms 502, 506 which may synchronize with the application voltage, charge, electric field, or combinations thereof applied to the flame 310 through the electrode 308 and according to the waveforms 502, and 504.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

1. A combustion system, comprising:
a controller;
a fuel control apparatus operatively coupled to the controller, the fuel control apparatus configured to output a series of fuel pulses into a combustion volume responsive to control by the controller;
a first voltage source operatively coupled to the controller, the first voltage source configured to output a first series of high voltage pulses responsive to control by the controller; and
a first ionizer configured to receive the first series of high voltage pulses and eject first charges onto one or more of the series of fuel pulses to charge the series of fuel pulses.

2. The combustion system of claim 1, wherein the controller is configured to cause the fuel control apparatus and the first ionizer to cooperate to output the series of fuel pulses with the series of fuel pulses carrying sequentially opposite polarity charges.

3. The combustion system of claim 2, wherein the series of fuel pulses carrying sequentially opposite polarity charges are electrostatically attracted to one another and form a series of fuel streams that flow together to form respective vortices.

4. The combustion system of claim 2, wherein the series of fuel pulses carrying sequentially opposite polarity charges are electrostatically attracted to one another and are selected to form a series of vortices separated in space from one another.

5. The combustion system of claim 4, wherein the series of fuel pulses carrying sequentially opposite polarity charges are selected to form Taylor layers between the series of vortices.

6. The combustion system of claim 5, wherein electrostatically-driven flow of the Taylor layers into the series of vortices is selected to cause air and/or flue gas engulfment into the respective vortices.

7. The combustion system of claim 5, wherein electrostatically-driven flow of the Taylor layers into the series of vortices is selected to cause air or flue gas engulfment into the respective vortices at a selected mixing rate in the vortices corresponding to a Damkohler Number equal to or greater than 1.

8. The combustion system of claim 1, further comprising:
a second voltage source operatively coupled to the controller; and
a second ionizer operatively coupled to the second voltage source.

9. The combustion system of claim 8, wherein the first voltage source is configured to output a first unipolar voltage and the second voltage source is configured to output a second unipolar voltage opposite in sign from the first unipolar voltage.

10. The combustion system of claim 8, wherein the controller is configured to:
cause the fuel control apparatus and the first ionizer to cooperate to output a series of fuel pulses carrying first polarity charges; and
cause the fuel control apparatus and the second ionizer to cooperate to output a series of fuel pulses carrying second polarity charges opposite in polarity from the first polarity charges.

11. The combustion system of claim 10, wherein the series of fuel pulses carrying sequentially opposite polarity charges are electrostatically attracted to one another and form a series of fuel streams that flow together to form respective vortices.

12. The combustion system of claim 10, wherein the series of fuel pulses carrying sequentially opposite polarity charges are electrostatically attracted to one another and are selected to form a series of vortices separated in space from one another.

13. The combustion system of claim 12, wherein the series of fuel pulses carrying sequentially opposite polarity charges are selected to form Taylor layers between the series of vortices.

14. The combustion system of claim 13, wherein electrostatically-driven flow of the Taylor layers into the series of vortices is selected to cause air or flue gas engulfment into the respective vortices.

15. The combustion system of claim 13, wherein electrostatically-driven flow of the Taylor layers into the series of vortices is selected to cause air or flue gas engulfment into the respective vortices at a selected mixing rate in the vortices corresponding to a Damkohler Number equal to or greater than 1.

16. The combustion system of claim 1, wherein the fuel control apparatus and the first ionizer are configured as an electrostatic ionizing fuel injector.

17. The combustion system of claim 1, further comprising:
a second ionizer; and
wherein the fuel control apparatus, the first ionizer, and the second ionizer are configured as a bipolar electrostatic ionizing fuel injector.

18. The combustion system of claim 17, wherein the first ionizer is configured as a first ion-ejecting mesh and the second ionizer is configured as a second ion-ejecting mesh electrically insulated or isolated from the first ion-ejecting mesh.

19. The combustion system of claim 17, wherein the first ionizer includes a first carbon nanotube (CNT) coating and the second ionizer includes a second CNT coating electrically insulated or isolated from the first CNT coating.

20. The combustion system of claim 1, further comprising a flame holder configured to anchor a flame formed as a series of vortices formed from the series of charged fuel pulses.

21. The combustion system of claim 20, wherein the flame holder includes a grounded conductor.

22. The combustion system of claim 20, wherein the flame holder includes a bluff body.

23. The combustion system of claim 20, wherein the flame includes charged Taylor layers between the vortices.

24. The combustion system of claim 1, further comprising a data communication interface included in or operatively coupled to the controller.

25. The combustion system of claim 24, wherein the controller is configured to receive data through the data communication interface and select a fuel control apparatus and ionizer pulse frequency responsive to the received data.

26. The combustion system of claim 24, wherein the controller is configured to receive data through the data communication interface and select a voltage source output voltage responsive to the received data.

27. The combustion system of claim 24, wherein:
the fuel control apparatus includes a fuel flow modulator; and
the controller is configured to receive data via the data communication interface and select a maximum modulated fuel flow rate for the fuel control apparatus responsive to the received data.

28. The combustion system of claim 1, wherein the fuel control apparatus includes one or more of a piezoelectric valve, an electro-magnetic valve, a rotary valve, a slide valve, an actuated ball valve, or a micro-electro-mechanical system (MEMS) valve.

29. The combustion system of claim 1, wherein the controller is configured to cause the fuel control apparatus and the first ionizer to output charged fuel pulses at one or more frequencies selected to avoid resonance in the combustion volume.

30. The combustion system of claim 1, wherein the controller is configured to cause the fuel control apparatus and the first ionizer to output charged fuel pulses at one or more frequencies that are sub-harmonics of a resonance frequency of the combustion volume.

31. The combustion system of claim 1, wherein the controller is configured to cause the fuel control apparatus and the first ionizer to output charged fuel pulses at a spread spectrum of frequencies selected to avoid resonance in the combustion volume.

32. The combustion system of claim 1, wherein the controller is configured to cause the fuel control apparatus and the ionizer to output charged fuel pulses at a range of frequencies including a low frequency corresponding to a low heat output rate from a flame supported by the charged fuel pulses.

33. The combustion system of claim 1, wherein the controller is configured to cause the fuel control apparatus and the first ionizer to output charged fuel pulses at a range of frequencies including a high frequency corresponding to a high heat output rate from a flame supported by the charged fuel pulses.

34. The combustion system of claim 1, wherein the controller is configured to cause the fuel control apparatus and the first ionizer to output charged fuel pulses at a low fuel volume per pulse corresponding to a low heat output rate from a flame supported by the charged fuel pulses.

35. The combustion system of claim 34, wherein the first ionizer is configured to apply a low total charge to the low fuel volume pulses.

36. The combustion system of claim 1, wherein the controller is configured to cause the fuel control apparatus and the first ionizer to output charged fuel pulses at a high fuel volume per pulse corresponding to a high heat output rate from a flame supported by the charged fuel pulses.

37. The combustion system of claim 36, wherein the first ionizer is configured to apply a high total charge to the high fuel volume pulses.

38. The combustion system of claim 1, wherein the controller is configured to drive the first voltage source to output a voltage proportional to a fuel flow rate of fuel output by the fuel control apparatus.

39. The combustion system of claim 1, wherein the controller is configured to drive the fuel control apparatus to output a fuel flow rate proportional to an output voltage of the first voltage source.

40. The combustion system of claim 1, wherein the fuel pulses are formed as a fuel aerosol.

41. The combustion system of claim 1, further comprising one or more field electrodes configured to apply one or more electric fields to drive movement of the charged fuel pulses or charged vortices produced by the charged fuel pulses.

42. The combustion system of claim 1, wherein the first voltage source is configured to cause the ionizer or a plurality of ionizers to output unequal amounts of positive and negative ions onto a series of fuel pulses such that combustion vortices produced by the fuel pulses carry a bias charge or bias voltage.

43. A method for controlling a combustion reaction, the method comprising:
modulating a fuel control apparatus to output a series of fuel pulses;
modulating an ionizer to apply charges to the series of fuel pulses; and
supporting a combustion reaction with the series of charged fuel pulses.

44. The method of claim 43, further comprising selecting a fuel control apparatus modulation frequency.

45. The method of claim 44, wherein the fuel control apparatus is selected to be proportional to an ionizer modulation frequency.

46. The method of claim 43, further comprising selecting an ionizer modulation frequency.

47. The method of claim 46, wherein the ionizer modulation frequency is selected to be proportional to a fuel control apparatus modulation frequency.

48. The method of claim 43, further comprising selecting a fuel control apparatus modulated flow rate.

49. The method of claim 48, wherein the fuel control apparatus modulated flow rate is selected to be proportional to an ionizer charge ejection rate.

50. The method of claim 43, further comprising selecting an ionizer modulated charge ejection rate.

51. The method of claim 50, wherein the ionizer modulated charge ejection rate is selected to be proportional to a fuel control apparatus modulated flow rate.

52. The method of claim 43, further comprising selecting an ionizer modulated charge phase relative to a fuel control apparatus modulation phase to synchronize charge output to a presence of a modulated fuel pulse.

53. The method of claim 43, further comprising causing the charged fuel pulses to form vortices.
